(19) United States
(12) Patent Application Publication
(10) Pub. No.: US 2013/0020483 A1
(43) Pub. Date: Jan. 24, 2013

(54) APPARATUS FOR PHOTOIONIZATION OF AN ANALYTE IN AN ELUENT OF A CHROMATOGRAPHY COLUMN

(71) Applicant: Joseph A. Jarrell, Newton Highlands, MA (US)

(72) Inventor: Joseph A. Jarrell, Newton Highlands, MA (US)

(73) Assignee: WATERS TECHNOLOGIES CORPORATION, Milford, MA (US)

(21) Appl. No.: 13/636,447

(22) PCT Filed: Apr. 6, 2011
(86) PCT No.: PCT/US11/31361

§ 371 Date: Sep. 21, 2012

Related U.S. Application Data
(60) Provisional application No. 61/322,319, filed on Apr. 9, 2010.

(51) Int. Cl. H01J 49/16

(52) U.S. Cl. 250/288

(57) ABSTRACT

Described is an apparatus for photoionization of an analyte in an eluent of a chromatography column. The apparatus includes a laser to generate a beam of optical radiation, a mass spectrometer and one or more optical components to receive the beam and to generate a concentrated region of optical radiation near an orifice of the mass spectrometer so that an analyte in the vapor phase of the eluent is ionized. Alternatively, the apparatus includes a laser driven light source, a mass spectrometer and an optical imaging system. The laser driven light source includes an optical enclosure having an ionizable medium, an ignition source and a laser for pumping optical radiation into the ionizable medium. The optical imaging system generates an image of the pumped region of the ionized medium proximate to the orifice of the mass spectrometer to thereby photoionize an analyte in the vapor phase of the eluent.

### CROSS-REFERENCE TO RELATED APPLICATIONS

This application claims priority to U.S. Provisional Application No. 61/322,319, filed on Apr. 9, 2010, the entire contents of which are incorporated herein by reference.

### FIELD OF THE INVENTION

The invention relates generally to atmospheric photoionization for liquid chromatography and gas chromatography systems. More particularly, the invention relates to a photoionization module having improved efficiency for ionizing analyte molecules.

### BACKGROUND

In recent years, liquid chromatography (LC) systems have been adapted so that the output of an LC system can interface directly to a mass spectrometer. The interface employs one of a variety of means for ionizing analytes of interest in the eluent while preventing most of the chromatographic solvents from entering the mass spectrometer vacuum system. According to an electrospray technique known in the art, the LC eluent is converted into a charged spray and charged analyte molecules are formed as the spray droplets evaporate. In an alternative technique referred to as atmospheric pressure chemical ionization (APCI), the LC eluent is converted to an electrically neutral spray. Typically, a corona discharge is used to ionize reagent ions which then transfer their charge to neutral analyte molecules.

Photoionization techniques are sometimes used at atmospheric pressure to interface the output of the LC system to the mass spectrometer. According to these techniques, the LC eluent is converted into a neutral spray that evaporates similar to the APCI process. The analyte molecules formed as the spray droplets evaporate are ionized by optical radiation comprising photons having sufficiently short wavelengths. In some photoionization techniques, the optical radiation ionizes a reagent or a dopant molecule which then transfers its charge to neutral analyte molecules of interest. Atmospheric pressure photoionization (APPI) techniques for interfacing the output of gas chromatography (GC) systems to mass spectrometers have also been developed.

Atmospheric pressure ionization sources for mass spectrometry include an inlet orifice disposed between the region of atmospheric pressure and a region of lower pressure inside the mass spectrometer. The size of the orifice is typically small to maintain the required vacuum level according to the capability of the vacuum pump. For example, the diameter of the orifice is between 100 μm and 500 μm in many mass spectrometer applications. Sample ions pass from the atmospheric region (or higher pressure region) into the vacuum region (or lower pressure region) through the orifice. During this process, components in the vapor phase of the LC eluent are deposited along the circumference of the inlet orifice. Over time the deposited material can reduce the effective size of the orifice, thereby reducing the sensitivity of the mass spectrometer. Various techniques have been developed to address the problem of orifice blockage. For example, the LC or GC output probe can be configured to be orthogonal to the inlet path to the orifice, resulting in a slower buildup of deposited material. Systems using such techniques still require cleaning or replacement of the orifice after extended periods of use.

The present invention addresses the need for an apparatus for photoionization of analytes for use with LC systems and GC systems that has improved sensitivity and addresses the problems set forth above.

### SUMMARY

In one aspect, the invention features an apparatus for photoionization of an analyte in an eluent of a chromatography column. The apparatus includes a laser driven light source, a mass spectrometer and an optical imaging system. The laser driven light source includes an optical enclosure having an ionizable medium within the enclosure, an ignition source for ionizing the ionizable medium and a laser for pumping optical radiation into the ionized medium. The mass spectrometer has an orifice to receive an eluent of a chromatography column in a vapor phase. The optical imaging system generates an image of a region of the ionized medium that is pumped by the laser. The image is generated proximate to the orifice of the mass spectrometer to photoionize at least one analyte in the vapor phase of the eluent received at the orifice.

In another aspect, the invention features an apparatus for ionization of an analyte in an eluent of a chromatography column. The apparatus includes a laser to generate a beam of optical radiation and a mass spectrometer having an orifice to receive an eluent of a chromatography column in a vapor phase. The apparatus also includes at least one optical component to receive the laser beam and to generate a concentrated region of optical radiation proximate to the orifice of the mass spectrometer to ionize at least one analyte in the vapor phase of the eluent received at the orifice.

In yet another aspect, the invention features an apparatus for cleaning an orifice of a mass spectrometer. The apparatus includes an optical source to generate an optical beam. The apparatus also includes at least one optical component to receive the optical beam and to generate a concentrated region of optical radiation proximate to an orifice of a mass spectrometer. The orifice has a structure that defines an opening to the mass spectrometer to receive an eluent from a chromatography column in a vapor phase. The concentrated region of optical radiation is sufficient to heat the structure of the orifice to maintain the orifice in an unobstructed condition.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is an illustration of an embodiment of an apparatus for photoionization and analysis of an analyte in an eluent of a chromatography column according to the invention.

FIG. 2 is an illustration of another embodiment of an apparatus for photoionization and analysis of an analyte in an eluent of a chromatography column according to the invention.

FIG. 3 is an illustration of another embodiment of an apparatus for photoionization and analysis of an analyte in an eluent of a chromatography column according to the invention.

FIG. 4 is an illustration of another embodiment of an apparatus for photoionization and analysis of an analyte in an eluent of a chromatography column according to the invention.

FIG. 5 is an illustration of another embodiment of an apparatus for photoionization and analysis of an analyte in an eluent of a chromatography column according to the invention.

FIG. 6 is an illustration of an apparatus for cleaning an orifice of a mass spectrometer according to the invention.

FIG. 7 is an illustration of another embodiment of an apparatus for photoionization and analysis of an analyte in an eluent of a chromatography column according to the invention.

FIG. 8 is an illustration of another embodiment of an apparatus for photoionization and analysis of an analyte in an eluent of a chromatography column according to the invention.

### DETAILED DESCRIPTION

Reference in the specification to “one embodiment” or “an embodiment” means that a particular, feature, structure or characteristic described in connection with the embodiment is included in at least one embodiment of the teaching. The appearances of the phrase “in one embodiment” in various places in the specification are not necessarily all referring to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

APPI sources traditionally use Krypton discharge lamps that operate at low pressure. Consequently, the optical radiation generated by these lamps is primarily concentrated in narrow spectral lines. Photoionization of an analyte occurs if the energy of the generated photons is greater than the energy that binds an electron to an analyte molecule. Optical radiation from discharge lamps is generally omnidirectional and the discharge region typically has significant spatial extent. Moreover, discharge lamps are generally used without imaging optics. Thus discharge lamps generally are inefficient for ionizing analyte molecules.

In brief overview, the invention relates to an apparatus for photoionization of an analyte in an eluent of a chromatography column. The apparatus includes a laser to generate a beam of optical radiation, a mass spectrometer and one or more optical components to receive the beam and to generate a concentrated region of optical radiation near an orifice of the mass spectrometer. The concentrated optical radiation ionizes an analyte in the vapor phase of the eluent. Alternatively, the apparatus includes a laser driven light source, a mass spectrometer and an optical imaging system. The laser driven light source includes an optical enclosure having an ionizable medium, an ignition source and a laser for pumping optical radiation into the ionizable medium. The optical imaging system generates an image of the pumped region of the ionized medium near or at the orifice of the mass spectrometer to thereby photoionize an analyte in the vapor phase of the eluent.

An apparatus 10 for photoionization and analysis of an analyte in an eluent of a chromatography column according to an embodiment of the invention is shown in FIG. 1. The apparatus 10 includes a laser driven (LD) light source 14, an optical imaging system 18 and a mass spectrometer 22.

The LD light source 14 includes an optical enclosure 26, such as a lamp envelope, that contains an ionizable medium, such as a high pressure gas (e.g., Xenon gas), and an ignition source 30 to ionize the medium within the enclosure 26. The ignition source 30 can include one or more electrodes to establish an electrical discharge. In one embodiment, a pair of electrodes comprising an anode and a cathode is used to ionize the medium. In an alternative embodiment, a radioactive source (e.g., Americium-241 or Strontium-90) is used for ionization of the medium within the optical enclosure 26. The radioactive source can be disposed inside or outside the optical enclosure 26, or integrated into the structure of the optical enclosure 26.

The LD light source 14 also includes one or more lasers, such as the illustrated diode laser 34, and one or more optical components such as a lens 38 to direct and to focus or concentrate the optical radiation generated by the laser 34 into a portion of the ionized medium. By way of example, the diode laser 34 may have a wavelength in the near infrared (e.g., 950 nm) that is strongly absorbed by the ionizable medium. In one embodiment, optical radiation from the diode laser 34 is coupled into an optical fiber and collimated before being focused by the lens 38 into the ionized medium. In another embodiment, the LD light source 14 includes a plurality of diode lasers such as a laser diode array. Other optical configurations for efficiently coupling optical radiation from one or more lasers into one or more beams for pumping the ionized medium will be recognized by those of skill in the art.

In various embodiments, the LD light source 14 comprises a light source as described in U.S. Pat. No. 7,435,982 issued to Smith, which is hereby incorporated by reference.

During operation of the apparatus 10, the electrode 30 initiates an electrical discharge, thereby generating an ionized region inside the optical enclosure 26. Optical radiation emitted by the diode laser 34 is focused or imaged into a portion of the ionized region where it is absorbed, resulting in a high temperature plasma 42. The plasma 42 is a source of light having substantially continuous spectral content with significant energy at ultraviolet (UV) wavelengths. Preferably, the size of the focused or imaged radiation within the ionized region is small with respect to the full ionized region so that the spatial extent of the plasma 42 is also small (e.g., on the order of 100 μm diameter), resulting in a higher brightness LD light source 14 used to photoionize analytes in the LC/GC output. The radiant power of the light emitted from the enclosure 26 is typically determined by the optical power of the focused optical radiation. The optical power available from commercially-available diode lasers enables the temperature of the plasma 42 to be sufficiently high to support emission of optical radiation with significant spectral content in the ultraviolet spectral range and, in some instances, the vacuum UV (VUV) spectral range. In general, UV photons and especially VUV photons have sufficient energy to ionize analyte molecules of interest.

In one embodiment, the optical enclosure 26 comprises a material such as fused silica that has a high UV transmittance. In a preferred embodiment, at least a portion of the optical enclosure 26 is fabricated from a material that transmits radiation at VUV wavelengths. In one embodiment, the optical enclosure 26 includes a window having transmittance in at least a portion of the VUV spectrum. By way of example, a window fabricated from magnesium fluoride or other material that has a spectral transmittance that extends into the VUV spectrum can be used.

The optical imaging system 18 includes one or more optical components to generate an image of the plasma 42 near or at the sampling orifice 44 of the mass spectrometer 22. The illustrated imaging system 18 is depicted as a single reflective optical component such as a mirror coated for high reflectance at UV wavelengths; however, other optical components known in the art can be used. In various embodiments, the optical imaging system 18 includes one or more reflective elements, refractive elements or a combination of reflective and refractive elements that have high reflectance or transmittance in the UV spectrum. The optical imaging system 18 generates an image of the plasma 42 at a desired image size so that a sufficient concentration of optical radiation is present near or at the orifice 44 at wavelengths necessary to enable ionization of analytes of interest.

Atmospheric pressure interfaces for mass spectrometers frequently have the sampling orifice 44 disposed at the tip of a cone. Typically, the diameter of the orifice 44 is between about 100 μm to 500 μm. The orifice diameter is determined according to the capabilities of the vacuum pump system 46 and the vacuum level necessary for proper operation of the mass spectrometer 22. If the emitting region of the LD light source 14 (i.e., the size of the plasma 42) has a size that is approximately the same as the size of the orifice 44, radiation from the plasma 42 is imaged near or at the sampling orifice 44 without magnification. In other embodiments, the optical imaging system 18 is selected to have a magnification such that the size of the image is nearly equal to the orifice diameter. As a result of providing highly concentrated optical radiation near to the sampling orifice 44, the efficiency of ionization of the analyte material in the vapor phase, either as eluent from a GC column or a nebulized output of an LC column, increases. Consequently, an improvement in measurement capability of the chromatography system and mass spectrometer 22 is realized.

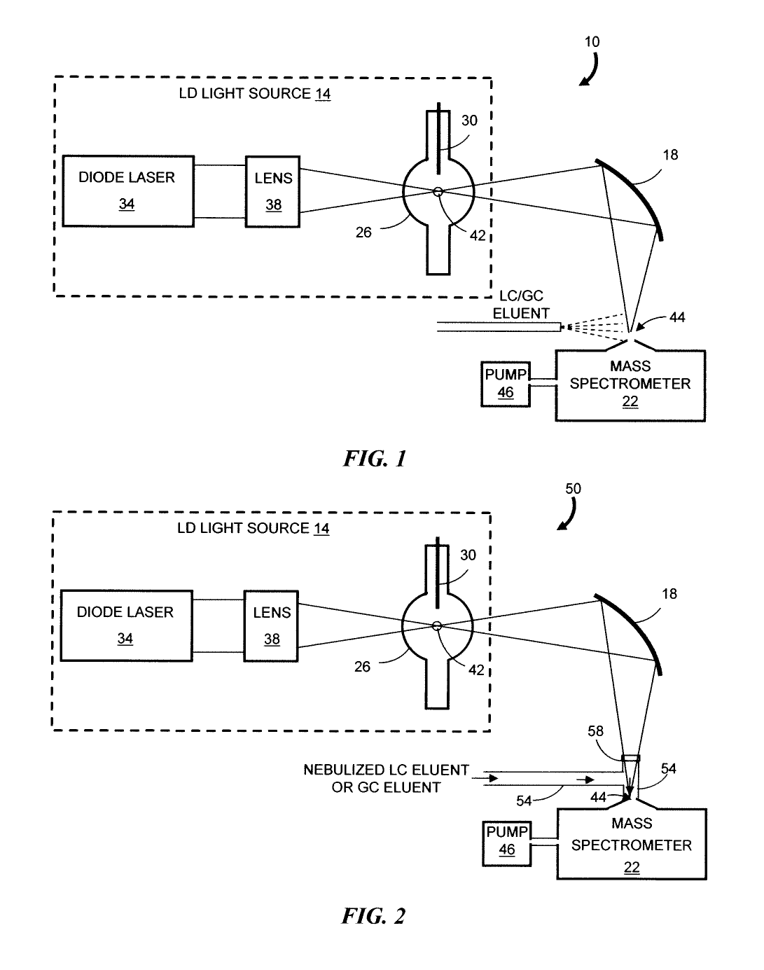

FIG. 2 illustrates another embodiment of an apparatus 50 for photoionization of an analyte in an eluent of a chromatography column according to the invention. The apparatus 50 includes components and modules similar to those shown in FIG. 1; however, the nebulized LC eluent (or GC eluent) flows through a flow cell 54 and is directed to the sampling orifice 44 of the mass spectrometer 22. A window 58 that is transparent to UV radiation, and preferably VUV radiation, is provided along a portion of the flow cell 54. By way of example, the window 58 may be fabricated from magnesium fluoride.

Optical radiation emitted from the plasma 42 is imaged inside the flow cell 54 in the flow of the nebulized LC eluent. Photoionized analyte continues along the flow and is directed toward the sampling orifice 44 of the spectrometer 22. In some applications, the apparatus 50 has advantages relative to the apparatus 10 of FIG. 1. For example, in capillary GC and some nanospray applications advantages the flow rate of the eluent is low. The flow cell 54 prevents the emerging eluent from spreading out and becoming diluted by the surrounding atmosphere. In other embodiments where the flow rate of the eluent is sufficiently high and the loss of sensitivity due to loss of some of the analyte is acceptable, the window 58 is omitted from the flow cell 54 and an opening in the wall of the flow cell 54 allows the radiation from the plasma 42 to be imaged near or at the orifice 44.

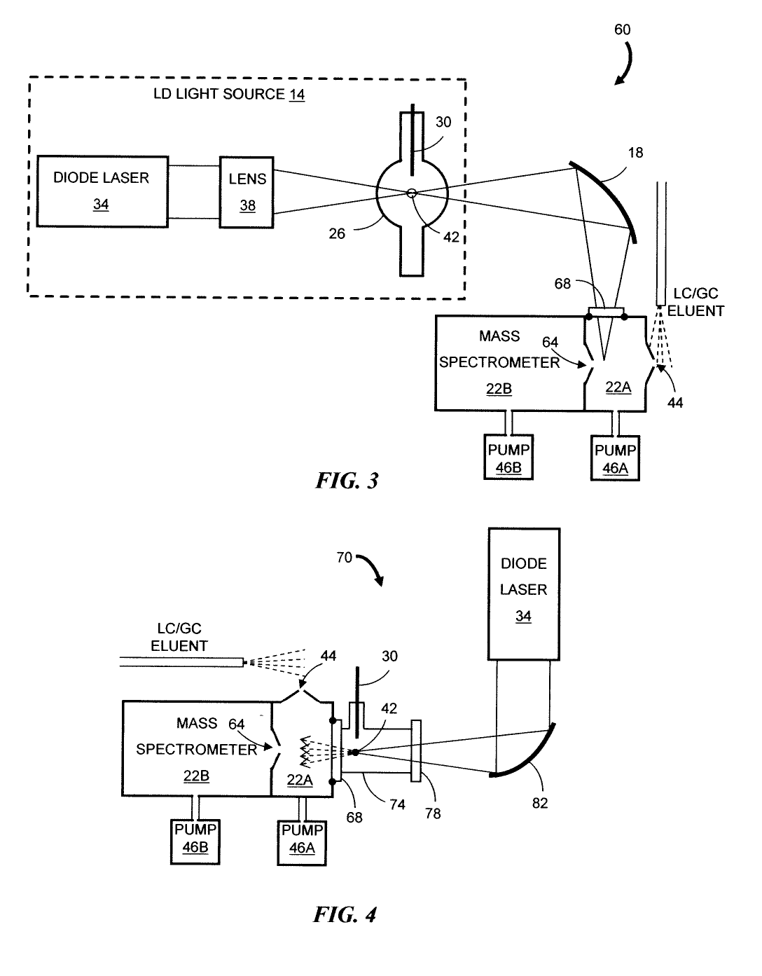

FIG. 3 shows an alternative apparatus 60 according to another embodiment of the invention. The apparatus 60 includes components and modules similar to those shown in FIG. 1; however, the mass spectrometer 22 includes two stages 22A and 22B according to a differential pumping configuration as is known in the art. The first stage 22A is maintained at a partial vacuum that is less than atmospheric pressure (e.g., in a range between 1 torr and 10 torr) but greater than the pressure in the second stage 22B (e.g., in a range of 10⁻⁵ torr to less than 10⁻⁷ torr). Each stage 22 is independently maintained at an appropriate vacuum level by a respective pumping system 46A or 46B. The first stage 22A includes a sampling orifice 44 as described above and the second stage 22B includes an additional orifice 64, or “skimmer,” at the interface with the first stage 22A. As illustrated, the orifices 44 and 64 have axes that are in a substantially collinear arrangement although other arrangements of the orifices 44 and 64 are possible.

The apparatus 60 also includes a window 68 that is transparent at UV wavelengths. The window 68 enables the image of the plasma 42 to be formed within the first stage 22A, preferably near the skimmer orifice 64. The window 68 is fabricated from a material having a high UV transmittance, such as fused silica, or preferably a material having a high VUV transmittance, such as magnesium fluoride.

In other embodiments, one or more additional stages may be included in the apparatus 60. The window 68 can be provided in any one of the stages so that the image of the plasma 42 can be generated near or at the orifice in the skimmer 64 disposed on the interface with the stage at the lower vacuum level to ionize analyte molecules moving toward the skimmer 64.

Photoionization at atmospheric pressure as shown in FIG. 1 generally results in creation of more ionized analyte than when photoionization occurs in the partial vacuum stage 22A of FIG. 3; however, the loss of ionized analyte is greater at the sampling orifice 44 of FIG. 1. Less neutral analyte is available for photoionization in the intermediate vacuum stage 22A of FIG. 3; therefore correspondingly fewer ionized analyte molecules are formed. Thus a preferred configuration is dependent on the efficiency of generating the ionized analyte and how effectively the ionized analyte can be transferred through the mass spectrometer 22.

FIG. 4 illustrates another apparatus 70 according to an embodiment of the invention. The orifices 44 and 64 of the mass spectrometer 22 are configured in an orthogonal arrangement such as the configuration disclosed in U.S. Pat. No. 5,756,994 to Bajic. The apparatus 70 includes an enclosure formed by a wall 74, a first optical window 78 that is substantially transparent to the pump radiation generated by the diode laser 34 and a second optical window 68 that is substantially transparent at wavelengths in the UV spectrum at wavelengths sufficient for ionization of the analyte. The wall 66 and windows 68 and 78 define an optical enclosure in which an ionizable medium is maintained. The second optical window 68 is integrated to the mass spectrometer 22 such that the window 68 is part of an interface between the first stage 22A of the mass spectrometer and the ionizable medium. A mirror 82, or one or more other optical components as are known in the art, is used to direct and focus the pump radiation from the diode laser 34 into a portion of the discharge initiated by the ignition source 30 near the second optical window 68. Optical radiation from the plasma 42 passes substantially without attenuation through the second optical window 68 and ionizes the analyte passing through the sampling orifice 44 in the first stage 22A.

In mass spectrometry, peptide ions are often fragmented prior to mass analysis. One method of peptide fragmentation involves reaction of peptide cations and electrons under subatmospheric conditions. This method is commonly referred to as Electron Capture Dissociation (ECD). In the ECD process, electrons may be generated by the photoionization of a reagent vapor such as toluene.

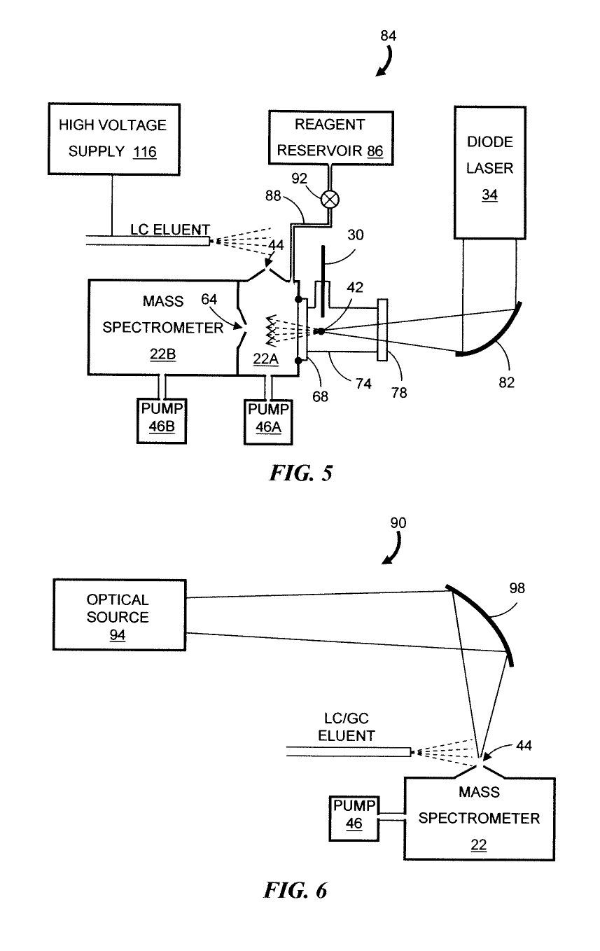

FIG. 5 shows another embodiment of an apparatus 84 according to the invention. The apparatus 84 is similar to the apparatus 70 of FIG. 3; however, the capillary is electrically coupled to a high voltage source 116 to enable an electrospray process as is known in the art and a reagent reservoir 86 is coupled to the first stage 22A of the mass spectrometer by a conduit 88. A variable leak valve 92 controls the flow of reagent passing from the reservoir 86 to the first stage 22A.

During operation, analyte ions form as the analyte molecules emerge in the LC eluent. The ions pass through the orifice 44 into the first stage 22A of the mass spectrometer. The reagent flowing from the reagent reservoir 86 into the first stage 22A is photoionized by the radiation from the plasma 42 and electrons are liberated in the process. The electrons react with multiply charged peptide ions passing through the first stage 22A to cause fragmentation. Using different reagents, this technique can be adapted to fragment peptide cations by an Electron Transfer Dissociation (ETD) process as is known in the art. The ETD process is similar to the ECD process except that the electrons may be donated from reagent anions. Alternatively, or in addition, electrons may be generated by the photoelectric effect when the radiation from the plasma 42 is incident on the walls of the first stage 22A. These electrons can participate in the ECD and ETD processes in the same way as the electrons that are liberated from the reagent.

In the various embodiments described above, the orifice 44 in the sampling cone of the mass spectrometer 22 is subject to blockage over extended periods of use. Moreover, deposits can affect the charge at the sampling orifice 44 such that the ability for analyte to pass through the orifice 44 is adversely affected. Conventional means for heating the sampling cone are inadequate for maintaining a clear orifice as the gas flowing through the orifice 44 cools the surrounding structure. Consequently, the mass spectrometer 22 must be periodically removed from service and the cone detached so that the orifice 44 can be cleaned.

In one embodiment shown in FIG. 6, an apparatus 90 for cleaning an orifice 44 of a mass spectrometer 22 according to the invention includes an optical source 94, such as a plurality of diode lasers, to generate an optical beam. The diode lasers can be the same type of laser as the diode lasers described above for achieving ionization although the regions in which the laser radiation is focused are different. Alternatively, the optical source 94 can include one or more sources of incoherent optical radiation. The apparatus 90 also includes at least one optical component 98 to receive the optical beam or beams from the optical source 94, and to generate a region of concentrated optical radiation near or at the orifice 44 at the tip of the sampling cone. Preferably, the size of the region of concentrated optical radiation is determined to optimize the optical radiation incident along and around the circumferential structure defining the orifice 44. The high temperature generated at the orifice structure achieved using the apparatus 90 overcomes limitations associated with conventional means for heating the sampling cone and results in the removal of deposits that would obstruct the orifice 44 and limit the amount of analyte passing to the spectrometer 22. In a preferred embodiment, the optical source 94 is operated continuously during measurement times to maintain a clear orifice 44.

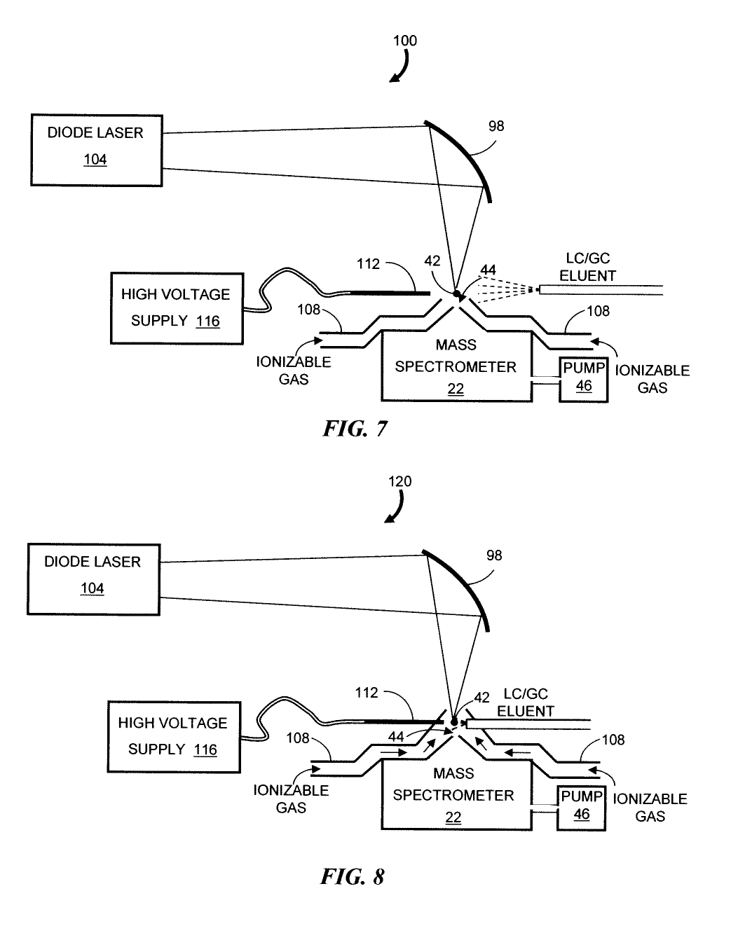

FIG. 7 illustrates an embodiment of an apparatus 100 for ionization of at least one analyte in an eluent of a chromatography column according to the invention. The apparatus 100 includes one or more diode lasers 104 to generate an optical beam and at least one optical component 98 to receive the optical beam and to generate a region of concentrated optical radiation in an ionizable gas for photoionization of the analyte. The gas is provided through one or more conduits 108 to the region near the orifice 44 of the mass spectrometer 22. Concentrated optical radiation is generated near or at the orifice 44. Optionally, a corona pin 112 coupled to a high voltage supply 116 is used to initiate a discharge in which a high temperature plasma 42 is formed.

Advantageously, the need for a window that is transparent to VUV radiation is eliminated. Moreover, the apparatus 100 does not utilize an optical enclosure and ignition source as certain other embodiments described above. Additionally, ionization and fragmentation may occur under some circumstances by analyte molecules traversing the high temperature plasma 42.

FIG. 8 illustrates another embodiment of an apparatus 120 for ionization of at least one analyte in an eluent of a chromatography column according to the invention. The apparatus includes components that are similar to those in the apparatus 100 of FIG. 7; however, the LC or GC eluent capillary and the corona pin 112 pass through the walls of the conduits 108 that provide the ionizable gas. One or more of the passages may be an opening in the conduit wall and one or more of the passages may include an insulator to electrically isolate the eluent capillary or corona pin 112 from the conduit wall. Advantageously, the apparatus 120 results in lesser dilution of the analyte when compared to the apparatus 100 of FIG. 7.

While the invention has been shown and described with reference to specific embodiments, it should be understood by those skilled in the art that various changes in form and detail may be made therein without departing from the spirit and scope of the invention as recited in the accompanying claims. For example, many of the various embodiments disclosed above are directed to LC systems although those of skill in the art will appreciate that these embodiments can be modified or adapted for GC systems.

What is claimed is:

1. An apparatus for photoionization of an analyte in an eluent of a chromatography column, comprising:
a laser driven light source comprising:
an optical enclosure having an ionizable medium therein;
an ignition source for ionizing the ionizable medium within the optical enclosure; and
a laser for pumping optical radiation into the ionized medium within the optical enclosure;
a mass spectrometer having an orifice to receive an eluent of a chromatography column in a vapor phase; and
an optical imaging system to generate an image of a region of the ionized medium that is pumped by the laser, the image being generated proximate to the orifice of the mass spectrometer to photoionize at least one analyte in the vapor phase of the eluent received at the orifice.

2. The apparatus of claim 1 wherein the vapor phase of the eluent is a nebulized eluent of a liquid chromatography column.

3. The apparatus of claim 1 wherein the vapor phase of the eluent is an eluent of a gas chromatography column.

4. The apparatus of claim 1 wherein the laser driven light source further comprises at least one optical component to receive the optical radiation from the laser and to concentrate the optical radiation into a portion of a region of the ionized medium within the optical enclosure.

5. The apparatus of claim 1 wherein the optical imaging system comprises a refractive optical component.

6. The apparatus of claim 1 wherein the optical imaging system comprises a reflective optical component.

7. The apparatus of claim 1 wherein the laser comprises a plurality of diode lasers.

8. The apparatus of claim 1 wherein the ignition source comprises a radioactive source for ionizing the gas within the optical enclosure.

9. The apparatus of claim 1 wherein the optical enclosure includes an optical window that transmits optical radiation at vacuum ultraviolet wavelengths.

10. The apparatus of claim 1 wherein the orifice of the mass spectrometer is disposed at an interface between two stages of the mass spectrometer and wherein each of the stages is at a pressure that is less than atmospheric pressure.

11. The apparatus of claim 10 wherein the mass spectrometer comprises a window that is substantially transparent to ultraviolet radiation in an optical beam from the optical imaging system that forms the image of the region of the ionized medium that is pumped by the laser.

12. The apparatus of claim 1 further comprising a flow cell to receive the eluent in the vapor phase from the chromatography system and to conduct the eluent to the orifice of the mass spectrometer, the flow cell having a window to pass optical radiation received from the optical imaging system and wherein the image of the region of the ionized medium is generate in the flow cell.

13. The apparatus of claim 1 further comprising a flow cell to receive the eluent in the vapor phase from the chromatography system and to conduct the eluent to the orifice of the mass spectrometer, the flow cell having an opening to pass optical radiation received from the optical imaging system and wherein the image of the region of the ionized medium is generate in the flow cell.

14. The apparatus of claim 12 wherein the window of the flow cell is substantially transparent to ultraviolet radiation.

15. An apparatus for ionization of an analyte in an eluent of a chromatography column, comprising:
a laser to generate a beam of optical radiation;
a mass spectrometer having an orifice to receive an eluent of a chromatography column in a vapor phase; and
at least one optical component to receive the laser beam and to generate a concentrated region of optical radiation proximate to the orifice of the mass spectrometer to ionize at least one analyte in the vapor phase of the eluent received at the orifice.

16. The apparatus of claim 15 further comprising a corona pin disposed proximate to the orifice of the mass spectrometer and configured to initiate a discharge in a region adjacent to at least a portion of the corona pin in response to an applied voltage.

17. The apparatus of claim 15 further comprising a conduit to provide an ionizable gas proximate to the orifice of the mass spectrometer.

18. The apparatus of claim 15 further comprising an optical enclosure integrated into a stage of the mass spectrometer, the optical enclosure comprising:
a first optical window that is transparent to the laser beam;
a second optical window that is substantially transparent to ultraviolet radiation and disposed near an internal side of the orifice; and
an enclosure wall, wherein the first and second optical windows and the enclosure wall enclose an ionizable medium and wherein the concentrated region of optical radiation is generated near the second optical window.

19. The apparatus of claim 18 wherein the optical enclosure further comprises an ignition source for ionizing the ionizable medium within the optical enclosure.

20. The apparatus of claim 15 wherein the vapor phase of the eluent is a nebulized eluent of a liquid chromatography column.

21. The apparatus of claim 15 wherein the vapor phase of the eluent is an eluent of a gas chromatography column.

22. The apparatus of claim 15 wherein the laser comprises a plurality of diode lasers.

23. The apparatus of claim 18 further comprising a reagent reservoir coupled to the stage of the mass spectrometer and configured to provide a reagent to enable the fragmentation of peptide ions according to one of an Electron Capture Dissociation process and an Electron Transfer Dissociation process.

24. The apparatus of claim 19 wherein the ignition source comprises a radioactive source for ionizing the ionizable medium within the optical enclosure.

25. An apparatus for cleaning an orifice of a mass spectrometer, comprising:
an optical source to generate an optical beam;
at least one optical component to receive the optical beam and to generate a concentrated region of optical radiation proximate to an orifice of a mass spectrometer, the orifice having a structure that defines an opening to the mass spectrometer to receive an eluent from a chromatography column in a vapor phase, the concentrated region of optical radiation sufficient to heat the structure of the orifice to maintain the orifice in an unobstructed condition.

26. The apparatus of claim 25 wherein the optical source comprises at least one laser.

27. The apparatus of claim 25 wherein the optical source comprises at least one source of incoherent optical radiation.
